(19) United States
(12) Patent Application Publication
(10) Pub. No.: US 2012/0054690 A1
(43) Pub. Date: Mar. 1, 2012

(54) APPARATUS AND METHOD FOR DISPLAYING THREE-DIMENSIONAL (3D) OBJECT

(75) Inventor: Jong U. LIM, Seoul (KR)

(73) Assignee: PANTECH CO., LTD., Seoul (KR)

(21) Appl. No.: 12/976,589

(22) Filed: Dec. 22, 2010

(30) Foreign Application Priority Data
Sep. 1, 2010 (KR) 10-2010-0085446

(51) Int. Cl. G06F 3/048

(52) U.S. Cl. 715/852

(57) ABSTRACT

Provided are an apparatus and a method for displaying a three-dimensional (3D) object. The apparatus may include a display panel to display a 3D object having plural faces, an object generating unit to rotate the displayed 3D object in a rotation direction of the apparatus to display a second face of the 3D object toward the user if at least one of a first operation and a second operation occurs, the first operation being that the apparatus is rotated while a user is touching a first face of the plural faces of the 3D object and the second operation being that the face of the user is rotated while the user is touching the first face of the plural faces of the 3D object, and a control unit to perform a function mapped to the other face displayed toward the user.

### CROSS-REFERENCE TO RELATED APPLICATION

This application claims priority from and the benefit under 35 U.S.C. §119(a) of Korean Patent Application No. 10-2010-0085446, filed on Sep. 1, 2010, which is hereby incorporated by reference for all purposes as if fully set forth herein.

### BACKGROUND

1. Field

Exemplary embodiments of the present invention relate to an apparatus and a method for displaying a three-dimensional (3D) object.

2. Discussion of the Background

A user terminal may display various menus using a three-dimensional (3D) object. A typical 3D object display technology may provide a stereoscopic effect using separate images is caused by a difference in vision between a left eye and a right eye; however, the technology may show a same display even if a line of sight of a user changes. That is, a typical 3D object display technology may show the same user interface (UI) regardless of a location of a user.

Conventionally, a 3D object display technology using a head tracking scheme may enable a UI to vary depending on a line of sight of a user. However, the technology may have an application range limited to a fixed equipment, such as a television. If the 3D object display technology using a head tracking scheme is applied to a mobile equipment, such as a portable appliance, an additional device may be needed, for example, glasses with an infrared device, resulting in awkward applicability.

### SUMMARY

Exemplary embodiments of the present invention provide an apparatus and a method for displaying a three-dimensional (3D) object, which may provide a stereoscopic effect of a 3D object varying adaptively depending on a line of sight of a user.

Exemplary embodiments of the present invention provide an apparatus and a method for displaying a three-dimensional (3D) object that may display a 3D object having a vanishing point varying depending on a line of sight of a user in an apparatus having mobility, such as a user terminal, so that the 3D object may be displayed more stereoscopically. This may result from recognizing a change in a line of sight of a user by comparing photographic data measured by a camera with sensing data, and from generating a 3D object appropriate for the changed line of sight of the user.

Exemplary embodiments of the present invention provide an apparatus and the method for displaying a 3D object that may improve a display accuracy of a 3D object displayed based on a line of sight of a user using a small number of sensors, resulting in cost reduction and lightweight products.

Exemplary embodiments of the present invention provide an apparatus and the method for displaying a 3D object that may prevent a malfunction of a 3D menu even in a driving car through a stereoscopic feedback of a 3D object based on a line of sight of a user, resulting in an increased accuracy of motion recognition.

Exemplary embodiments of the present invention provide an apparatus and the method for displaying a 3D object that may recognize a change in a vanishing point based on a line of sight so that a 3D object may be displayed with fewer calculations.

Additional features of the invention will be set forth in the description which follows, and in part will be apparent from the description, or may be learned by practice of the invention.

An exemplary embodiment of the present invention discloses an apparatus to display a 3D object including a display panel to display the 3D object having plural faces; an object generating unit to rotate the displayed 3D object in a rotation direction of the apparatus to display a second face of the 3D object toward the user if at least one of a first operation and a second operation occurs, the first operation being that the apparatus is rotated while a user touches a first face of the plural faces of the 3D object and the second operation being that the face of the user is rotated while the user touches the first of the plural faces of the 3D object; and a control unit to perform a function mapped to the second face displayed toward the user.

An exemplary embodiment of the present invention discloses a method for displaying a 3D object of an apparatus including displaying the 3D object having plural faces; detecting occurrence of at least one of a first operation and a second operation, the first operation being that the apparatus is rotated while a first face of the plural faces of the 3D object is touched by a user and the second operation being that the face of the user is rotated while the first face of the plural faces of the 3D object is touched by the user; rotating and displaying the displayed 3D object in a rotation direction of the apparatus so that a second face of the 3D object is displayed toward the user; and performing a function mapped to the second face displayed toward the user.

An exemplary embodiment of the present invention discloses an apparatus to display a 3D object including a display panel to display the 3D object having plural faces; an object generating unit to rotate the displayed 3D object in a relative direction of the apparatus with respect to a user while the user touches a first face of the 3D object to display a second face of the 3D object toward the user according to a relative angle of the apparatus with respect to the user; and a control unit to perform a function mapped to the second face displayed toward the user if the touch of the first face of the 3D object is released.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is illustrates a method for measuring facial proportion data according to an exemplary embodiment of the present invention.

FIG. 2 is a block diagram illustrating an apparatus according to an exemplary embodiment of the present invention.

FIGS. 3A to 3C are views illustrating an example of a relative angle.

FIGS. 4A and 4B are views illustrating an example of a 3D object having a vanishing point varying depending on a relative angle and an inclination.

FIG. 5 is illustrates a 3D button as a 3D object having a vanishing point varying depending on a relative angle and an inclination of an apparatus.

FIG. 6 is a plan view illustrating a 3D button.

FIG. 7 is a block diagram illustrating an apparatus according to an exemplary embodiment of the present invention.

FIG. 8 is a block diagram illustrating an apparatus according to an exemplary embodiment of the present invention.

FIG. 9 is a flow chart illustrating a method for displaying a 3D object in an apparatus according to an exemplary embodiment of the present invention.

FIG. 10 is a flow chart illustrating a method for displaying various faces of a 3D object by varying a vanishing point of the 3D object according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

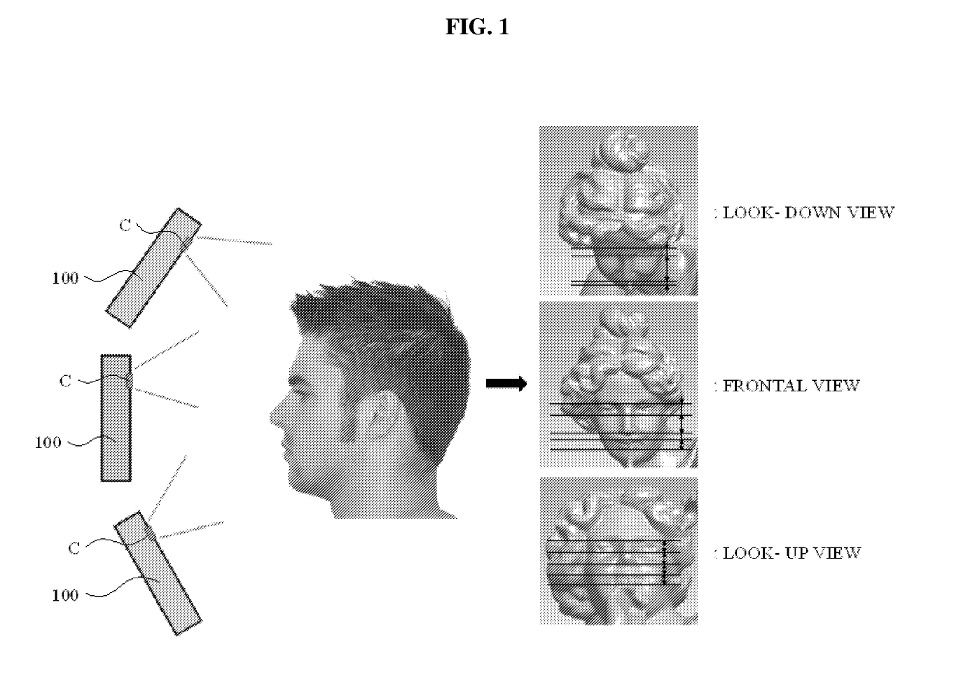

FIG. 1 is illustrates a method for measuring a facial proportion data according to an exemplary embodiment of the present invention.

Generally, a user of an apparatus 100 with camera functionality may be limited to one user. To measure facial proportion data, the apparatus 100 may photograph the face of a user using an embedded camera C. In this instance, the user may photograph a front part of the face using the camera C with the face looking straight ahead and motionless so as to photograph the “frontal view” of the user's face as shown in FIG. 1.

Also, the user may further photograph the face while moving or rotating the apparatus 100 in left, right, upward, and downward directions relative to the front as an origin. In this instance, the face of the user may keep looking straight ahead. Accordingly, the apparatus 100 may provide facial proportion data of the face of the user viewed in left, right, upward, and downward directions. For example, as shown in FIG. 1, a “look-down” view may be a shot taken while the apparatus 100 looks down on the face of the user, and a “look-up” view may be a shot taken while the apparatus 100 looks up on the face of the user.

The facial proportion data may represent proportion data in facial features, such as eyes, a nose, a mouth, and the like, viewed by the apparatus 100. For example, facial proportion data measured by the camera C looking down on the face of the user (i.e., the look-down view) may be different from facial proportion data measured by the camera C looking straight at the face of the user (i.e., the frontal view), as shown in FIG. 1.

Although FIG. 1 shows the camera C moving with respect to the face of the user, aspects are not limited thereto such that the user may move her face with respect to the camera C, i.e., the user may hold the camera C in place and look down so as to provide facial proportion data for the look-down view.

The facial proportion data may be stored for each angle between the face of the user and the apparatus 100. In this instance, an angle between the face of the user and the apparatus 100 looking straight at the face of the user may be 0°, which may be a reference angle.

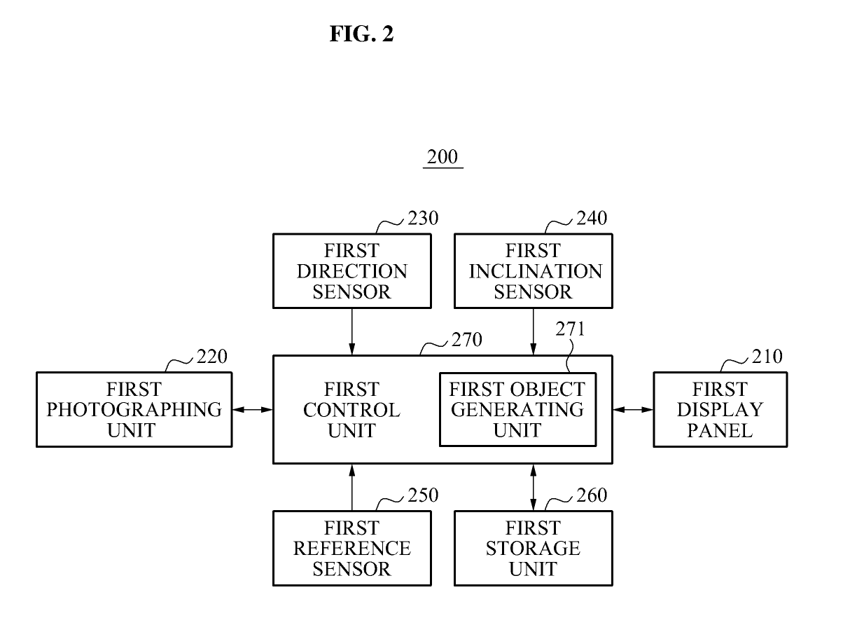

FIG. 2 is a block diagram illustrating an apparatus 200 according to an exemplary embodiment of the present invention.

Referring to FIG. 2, the apparatus 200 may display an object capable of interaction with a user in three dimensions. The apparatus 200 may be an apparatus, such as a mobile terminal, a smartphone, a mobile phone, a display device, a laptop computer, a tablet computer, a personal computer, and the like. The apparatus 200 of FIG. 2 may be the apparatus 100 of FIG. 1.

As shown in FIG. 2, the apparatus 200 may include a first display panel 210, a first photographing unit 220, a first direction sensor 230, a first inclination sensor 240, a first reference sensor 250, a first storage unit 260, a first control unit 270, and a first object generating unit 271.

The first display panel 210 may display a two-dimensional (2D) object or a 3D object under control of the control unit 270, and may display various images stored in the apparatus 200. The object may refer to any image displayed on the first display panel 210. The 3D object may be a stereoscopic object, and the 2D object may be a flat object.

The first display panel 210 may display a 3D object, of which a display type may vary depending on a line of sight of a user and a relative angle of the apparatus 200 to the face of the user. For example, if a user looks at the right side of the apparatus 200 or looks at the apparatus 200 from the right side, the first display panel 210 may display a 3D object having a changed inclination and a changed display type.

If the apparatus 200 operates in a 3D mode to display an object in three dimensions, the first photographing unit 220 may continuously photograph a user and output photographic data. The first photographing unit 220 may have a wide viewing angle range or field of view or angular field of view to photograph the face of the user. Alternatively, the first photographing unit 220 may track and photograph the face of the user under control of the first control unit 270, and may output photographic data about the face of the user. The first photographing unit 220 may be an embedded camera.

The first direction sensor 230 may sense a rotation direction of the first photographing unit 220 or the apparatus 200, and may include an accelerator sensor. The rotation direction may be a movement direction of the apparatus 200 by a user. For example, the rotation direction may be a left, right, upward, downward direction, or combinations thereof, relative to the front face of the user. The rotation direction may include data about a rotation angle of the apparatus 200. For ease of description, a rotation direction and a rotation angle may be used herein for the same meaning.

The first inclination sensor 240 may sense an inclination of the first photographing unit 220 or the apparatus 200, and may include a gyroscope. The inclination of the first photographing unit 220 or the apparatus 200 may be, for example, left, right, downward, upward, or combinations thereof. If the first display panel 210 of the apparatus 200 is opposite to the face of the user, i.e., the line of sight of the user is normal, or close to normal, to a plane of the first display panel 210, the first inclination sensor 240 may sense an inclination as 0°. If the first display panel 210 of the apparatus 200 is opposite to the face of the user and the apparatus 200 inclines in a right direction, the inclination may change such that the first display panel 210 may display an object according to the changed inclination of the photographing unit 220 or the apparatus 200.

The first reference sensor 250 may set x-axis or y-axis reference coordinates system of the first photographing unit 220, and may include a digital compass. The reference coordinate system may be used as a reference point or an origin to recognize a change in a line of sight of a user.

For example, after a 3D object is displayed, the first object generating unit 271 may generate a 3D object capable of changing a face displayed toward a user among plural faces of the 3D object by rotating the 3D object in a rotation direction sensed by the first direction sensor 230.

For example, after a 3D object is displayed, the first object generating unit 271 may generate a 3D object capable of changing a face displayed toward a user among plural faces of the 3D object by rotating the 3D object according to an inclination sensed by the first inclination sensor 240. The detailed description thereof will be made below.

As another example, after a 3D object is displayed, the first object generating unit 271 may generate a 3D object capable of changing a face displayed toward a user among plural faces of the 3D object by rotating the 3D object according to a rotation direction sensed by the first direction sensor 230 and an inclination sensed by the first inclination sensor 240.

The first storage unit 260 may store the facial proportion data described with reference to FIG. 1 based on an inclination and/or a rotation angle. The inclination may be an inclination of the apparatus 200, and the rotation angle may be an angle between the apparatus 200 and the face of a user. The rotation angle may vary depending on a rotation direction of the apparatus 200, and may be calculated using data sensed by the first direction sensor 230 and the first reference sensor 250.

The rotation angle may be calculated based on a position of the apparatus 200 where the apparatus 200 looks straight at the face of a user. That is, if the apparatus 200 photographs the user while the apparatus 200 looks straight at the face of the user, the rotation angle may be 0°, which may be used as a reference angle. Accordingly, the rotation angle may include data about an angle and a direction between the apparatus 200 and a line of sight of the user.

In the case of a plurality of users, the facial proportion data may be mapped and stored for each user.

The following Table 1 shows an example of facial proportion data measured according to FIG. 1 and stored for each rotation angle.

TABLE 1

| | | Facial proportion data | | |
|---|---|---|---|---|
| User 1 | | Look-Down View° | Frontal View | Look-Up View |
| Angle | 10° | Facial | Facial | Facial |
| of | | proportion | proportion | proportion |
| rotation | | data 1 | data 4 | data 7 |
| | 0° | Facial | Facial | Facial |
| | | proportion | proportion | proportion |
| | | data 2 | data 5 | data 8 |
| | −10° | Facial | Facial | Facial |
| | | proportion | proportion | proportion |
| | | data 3 | data 6 | data 9 |

With regard to Table 1, assuming a rotation angle is 0° if the apparatus 200 is opposite to a user while the user looks straight ahead, a rotation angle of 10° may be an angle if the apparatus 200 is moved at an angle of 10° in a right direction with reference to a user. A rotation angle of −10° may be an angle if the user looks straight ahead and the apparatus 200 is moved at an angle of 10° in a left direction with reference to the user.

The following Table 2 shows an example of facial proportion data measured according to FIG. 1 and stored for inclinations of 0°, 30°, and −30° and rotation angles of 0°, 10°, and −10°.

TABLE 2

Inclination (−180°~+180°)

| | | | |
|---|---|---|---|
| User 1 | 0° | 30° | −30° |

| | | | | |
|---|---|---|---|---|
| Angle | 10° | Facial | Facial | Facial |
| of | | proportion | proportion | proportion |
| rotation | | data 11 | data 14 | data 17 |
| | 0° | Facial | Facial | Facial |
| | | proportion | proportion | proportion |
| | | data 12 | data 15 | data 18 |
| | −10° | Facial | Facial | Facial |
| | | proportion | proportion | proportion |
| | | data 13 | data 16 | data 19 |

With regard to Table 2, an inclination of 0° may be an inclination of the apparatus 200 if the first display panel 210 of the apparatus 200 is opposite to a user.

The first control unit 270 may detect a line of sight of a user from photographic data outputted from the first photographing unit 220, and may recognize a change in a vanishing point based on the line of sight of the user.

If at least one of a first operation and a second operation occurs, the first operation being that the apparatus 200 is rotated or inclined while one of plural faces of a 3D object is touched and the second operation being that the face of a user is rotated while one of plural faces of the 3D object is touched, the first object generating unit 271 may rotate the 3D object in a rotation direction of the apparatus 200 so that another face of the 3D object is displayed toward the user.

In the second operation, the first object generating unit 271 may generate a 3D object having a face displayed toward a user varying depending on the line of sight of the user detected by the first control unit 270. The first object generating unit 271 may operate within the first control unit 270 or may operate separately from the first control unit 270. The first object generating unit 271 may generate a 3D object using a 3D object generation program based on a line of sight of a user or a relative angle described below. The generated 3D object may be displayed on the first display panel 210.

For example, if the apparatus 200 operates in a 3D mode, the first control unit 270 may control the first photographing unit 220 to photograph a user. Also, the first control unit 270 may control the first direction sensor 230 and the first inclination sensor 240 to sense a rotation direction and an inclination of the apparatus 200, respectively.

The first control unit 270 may determine a direction of a line of sight of a user by comparing the stored facial proportion data with the photographic data. Specifically, the first control unit 270 may detect facial data of a user from the photographic data outputted from the first photographing unit 220, and recognize a change in the line of sight of the user by analysis of the detected facial data. In this instance, the first control unit 270 may control the first photographing unit 220 to track and photograph the face of the user, using the facial data of the user.

The first control unit 270 may generate facial proportion data using the detected facial data, and may detect facial proportion data identical or similar to the generated facial proportion data stored in the first storage unit 260.

The first control unit 270 may recognize a rotation angle corresponding to the detected facial proportion data, and may determine that there is a change in a line of sight of a user if the recognized rotation angle is greater than or smaller than 0°. Also, the first control unit 270 may determine the recognized rotation angle as a direction of the line of sight of the user or an angle of the line of sight of the user. For example, if a rotation angle recognized in Table 1 is 10°, the first control unit 270 may determine that the line of sight of the user is directed toward an angle of 10° in a right direction relative to the front.

Also, the first control unit 270 may calculate a rotation direction and an inclination of the apparatus 200 using sensing data outputted from the first direction sensor 230 and the first inclination sensor 240. The rotation direction and the inclination of the apparatus 200 may be a rotation direction and an inclination of the first photographing unit 220.

The first control unit 270 may compare the determined direction of the line of sight of the user with the rotation direction and the inclination of the apparatus 200, and the first object generating unit 271 may generate a 3D object having a changed vanishing point. The first control unit 270 may compare the determined direction of the line of sight of the user with the calculated rotation direction, and may calculate a relative angle of the apparatus 200 to the line of sight of the user. Also, the first control unit 270 may compare the direction of the line of sight of the user with the inclination of the apparatus 200, and may calculate a relative angle of the apparatus 200 to the line of sight of the user. Thus, the relative angle may include at least one of a rotation angle of the apparatus 200 with respect to a user and an inclination of the apparatus with respect to a user.

The first object generating unit 271 may generate a 3D object having a vanishing point varying depending on the calculated relative angle. The first object generating unit 271 may generate a 3D object using the stored facial proportion data or using a 3D object generation scheme based on a relative angle. The 3D object generation scheme may designate a rotation degree of a 3D object, a rotation direction of the 3D object, a face displayed toward a user, and the like, based on a relative angle.

For example, if the line of sight of the user is opposite to the apparatus 200, the first object generating unit 271 may generate a 3D object corresponding to a relative angle of 0°.

If the line of sight of the user is directed toward the front and the apparatus 200 is moved at an angle of n° (n is a natural number) in a left or right direction, the first object generating unit 271 may generate a 3D object having a changed vanishing point corresponding to the relative angle of n°.

Also, the first object generating unit 271 may generate a polyhedral 3D object having a stereoscopic effect. The first object generating unit 271 may change a face displayed toward a user based on a relative angle, among plural faces of the 3D object. For example, if the apparatus 200 is rotated, the first object generating unit 271 may rotate a polyhedral 3D object in the same direction as a rotation direction of the apparatus 200 so that a face displayed toward a user may be changed.

In the case that a 3D object is, for example, a cube-shaped object having a stereoscopic effect, if the apparatus 200 is rotated at an angle of m° (m is a natural number) in a left direction, the first object generating unit 271 may enlarge a right face of the 3D object by rotating the 3D object at an angle of m° or greater, for example, at least twice m°, in a left direction so that the right face of the 3D object may be displayed toward a user. In this instance, the right face of the 3D object may be enlarged so as to display the right face of the 3D object to the user more clearly.

Among plural faces of a 3D object, a face displayed toward to a user may vary depending on a rotation direction of the apparatus 200.

If the apparatus 200 is rotated while a user is touching one of plural faces of a 3D object, the first object generating unit 271 may rotate the 3D object in the same direction as a rotation direction of the apparatus 200. Accordingly, another face of the 3D object may be displayed toward the user. If the other face of the 3D object is displayed toward the user, the user may release the touch and input a user command. That is, the user may request performance of a function corresponding to the other face of the 3D object.

If the other face of the 3D object is displayed toward the user by rotation of the 3D object and the touch of the one face is released by the user, the first control unit 270 may perform a function corresponding to the other face of the 3D object.

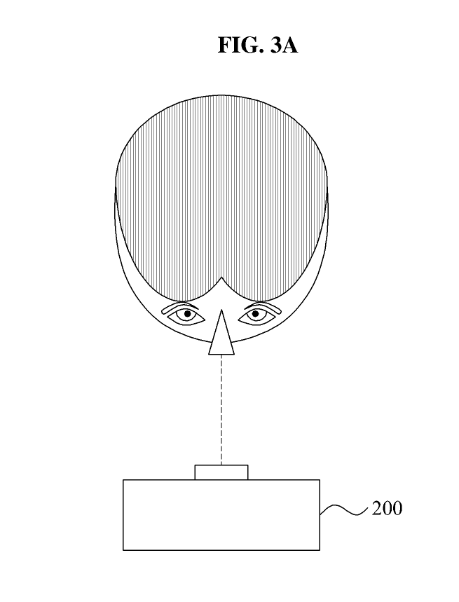

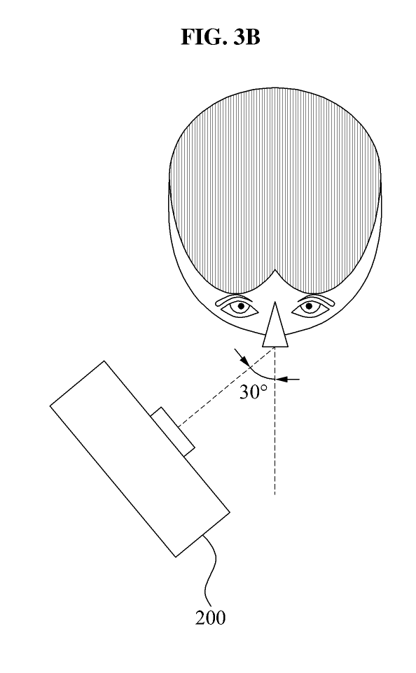

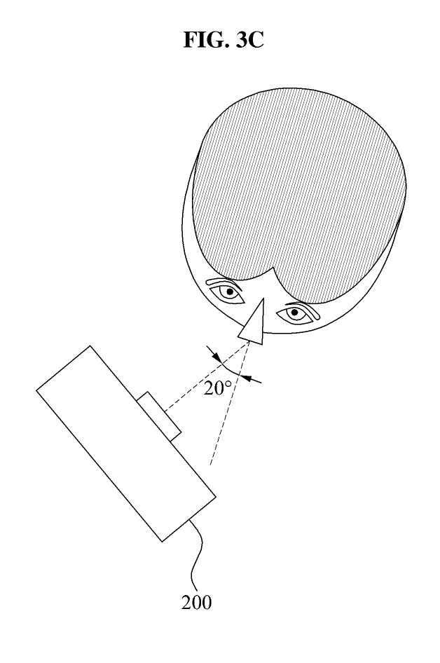

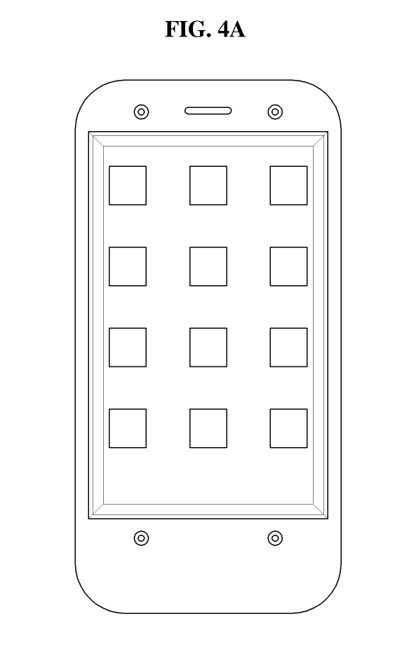

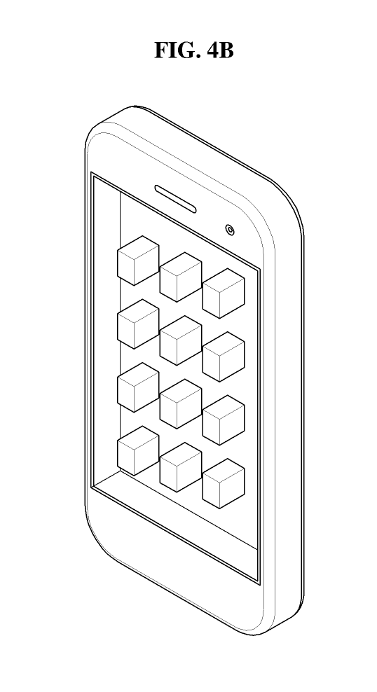

FIGS. 3A to 3C are views illustrating an example of a relative angle. FIGS. 4A and 4B are views illustrating an example of a 3D object having a vanishing point varying depending on a relative angle. The relative angle may include a rotation angle and an inclination.

As shown in FIG. 3A, assuming an inclination angle of 0°, if a line of sight of a user is directed toward the front, that is, there is no change in a line of sight of the user, and the apparatus 200 is opposite to the line of sight of the user, a relative angle is 0°. The first object generating unit 271 may generate a 3D object corresponding to the relative angle of 0°, that is, a 3D object directed toward the front. Accordingly, the user may see a 3D object displayed toward the front, as shown in FIG. 4A.

As shown in FIG. 3B, if a line of sight of a user is directed toward the front and the apparatus 200 is moved at an angle of 30° in a right direction, a relative angle is 30°. The first object generating unit 271 may generate a 3D object corresponding to the relative angle of 30°. Accordingly, the user may see a left face of the 3D object more clearly. The rotation of the apparatus 200 at an angle of 30° in a right direction may be detected from sensing data of the first direction sensor 230 and the first inclination sensor 240.

As shown in FIG. 3C, if a line of sight of a user is sensed as being moved at an angle of 10° in a right direction and the apparatus 200 is moved at an angle of 30° in a right direction, a relative angle is 20°. Accordingly, the first object generating unit 271 may generate a 3D object corresponding to the relative angle of 20°.

In this instance, if the apparatus 200 is inclined at an angle of 10° in a right direction, an inclination of the apparatus 200 is 10°. Accordingly, the first object generating unit 271 may generate a 3D object corresponding to the relative angle according to the rotation angle of 20° and the inclination of 10°.

If a line of sight of a user is directed toward the front and the apparatus 200 is moved at an angle of 20° in a left direction and inclined at 10°, a relative angle corresponds to a rotation angle of −20° and an inclination of 10°. In this instance, the first object generating unit 271 may generate a 3D object corresponding to the relative angle of −20°, as shown in FIG. 4B.

Further, although the relative angle is discussed with respect to a rotation direction and rotation angle, aspects are not limited thereto such that the relative angle may be applied to the inclination of the apparatus 200, and the relative angles of the rotation angle and the inclination angle may be combined.

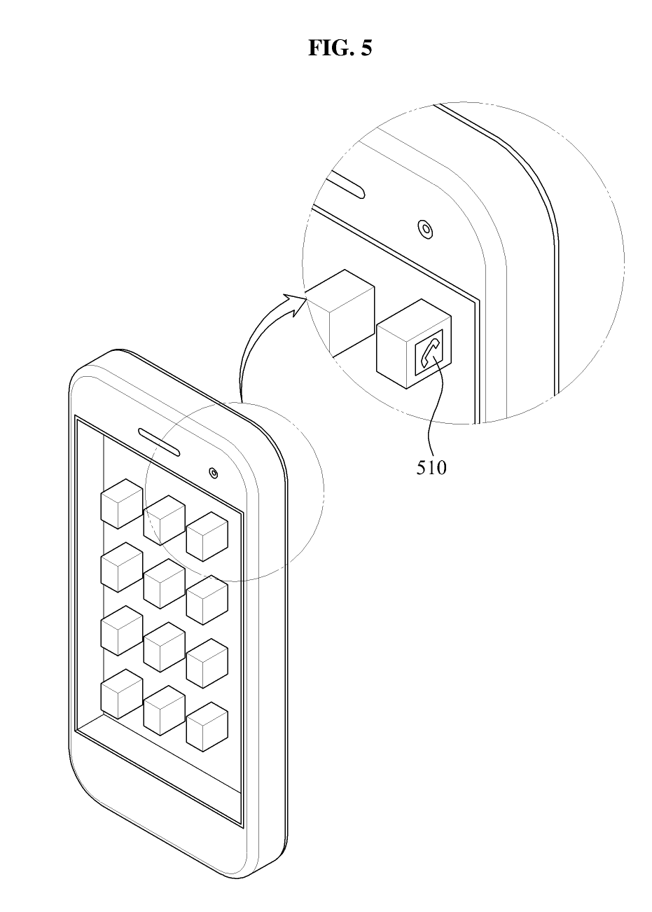

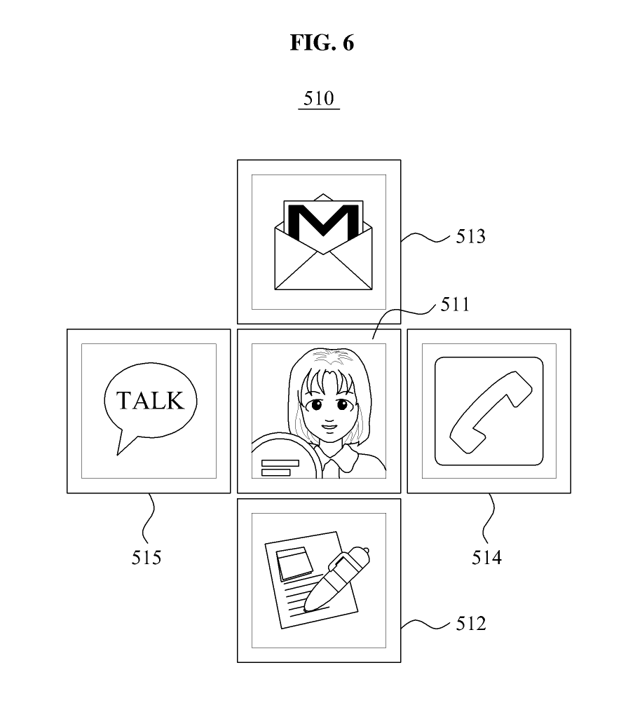

FIG. 5 is illustrates a 3D button 510 as a 3D object having a vanishing point varying depending on a relative angle and an inclination of the apparatus 200. FIG. 6 is a plan view illustrating the 3D button 510. Here, the 3D button 510 may be a 3D object.

Referring to FIG. 5, a relative angle of the apparatus 200 to a user corresponds to a rotation angle of −20° and an inclination is 10°. That is, the user may look straight ahead and the apparatus 200 may be rotated at an angle of 20° in a left direction and the apparatus 200 may be inclined at 10° similar to FIG. 4B. Accordingly, if the 3D button 510 has a cubic shape, the first object generating unit 271 may generate the 3D button 510 having a right face and a top face displayed more clearly, and may display the 3D button 510 on the first display panel 210 of the apparatus 200.

Referring to FIG. 6, the 3D button 510 may have a first face to a fifth face, and may have icons 511 to 515 having different functions for each face. As a relative angle may change, the first object generating unit 271 may change a vanishing point of the 3D button 510 and may generate the 3D button 510 having an icon corresponding to a relative angle and/or an inclination displayed to a user more clearly.

Specifically, if a user touches an icon (for example, the icon 511) of the 3D button 510 displayed toward the front of the user, the first control unit 270 may set the icon 511 of the touched face as an origin of rotation. If the user rotates the apparatus 200 in an arbitrary direction, for example, a left, right, upward, or downward direction, the first object generating unit 271 may display an icon of a face corresponding to the rotation direction relative to an origin. For example, if the user rotates the apparatus 200 in a left direction while the user is touching the icon 511, the first object generating unit 271 may rotate the 3D button 510 in a left direction so that the icon 514 of a right face may be displayed to the user more stereoscopically.

The first object generating unit 271 may rotate the 3D button 510 at an angle greater than the sensed rotation angle and/or inclination of the apparatus 200. For example, if the sensed rotation angle of the apparatus 200 is 20°, the first object generating unit 271 may rotate and display the 3D button 510 at an angle of 40°. Accordingly, the user may recognize the icon 514 displayed on a right face of the 3D button as shown in FIG. 5.

If a user command requesting performance of a function of the icon 514 is inputted, the first control unit 270 may perform a function of the icon 514. For example, if the icon 514 displayed by rotation and/or inclination of the 3D button 510 is an icon desired by a user, the user may release the touch of the icon 511. Accordingly, the first control unit 270 may perform a function corresponding to the displayed icon 514. Referring to FIG. 5, the first control unit 270 may perform a call function. Also, if the user rotates and/or inclines the apparatus 200 in a downward direction while the user is touching the icon 511 and then the user releases the touch of the icon 511, the first control unit 270 may perform a send mail function.

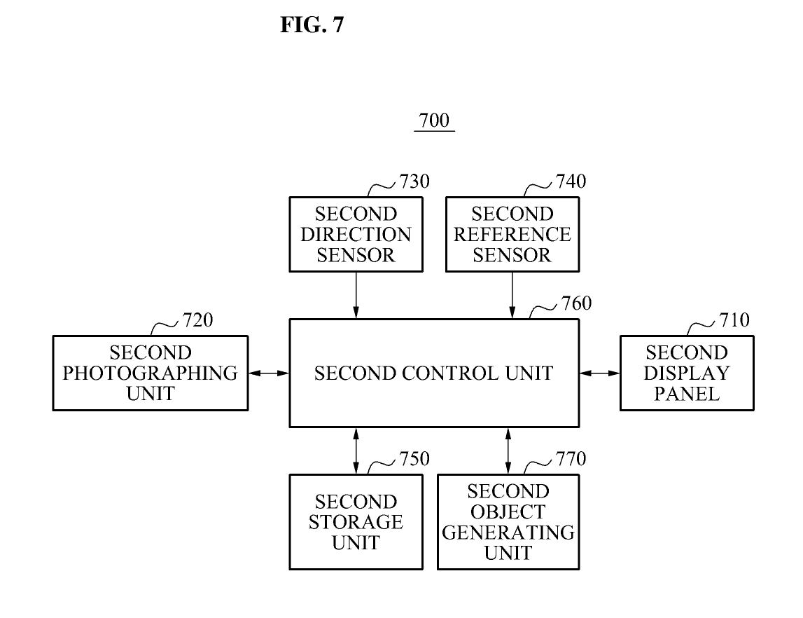

FIG. 7 is a block diagram illustrating an apparatus 700 according to an exemplary embodiment of the present invention.

Referring to FIG. 7, the apparatus 700 may be the apparatus 100 of FIG. 1.

The apparatus 700 may include a second display panel 710, a second photographing unit 720, a second direction sensor 730, a second reference sensor 740, a second storage unit 750, a second control unit 760, and a second object generating unit 770.

The second display panel 710, the second photographing unit 720, the second direction sensor 730, the second reference sensor 740, the second storage unit 750, the second control unit 760, and the second object generating unit 770 may be similar to the first display panel 210, the first photographing unit 220, the first direction sensor 230, the first reference sensor 250, the first storage unit 260, the first control unit 270, and the first object generating unit 271, and thus, detailed descriptions thereof may be omitted herein.

However, the apparatus 700 may sense a rotation direction of the apparatus 700 using data sensed by the second direction sensor 730 and the second reference sensor 740. Also, the apparatus 700 may recognize a change in a line of sight of a user by comparing photographic data measured by the second photographing unit 710 with facial proportion data stored in the second storage unit 750. Also, the apparatus 700 may generate a 3D object having a vanishing point varying depending on a relative angle of the apparatus 700 to the line of sight of the user. The apparatus 700 may perform such functions without the inclusion of an inclination sensor.

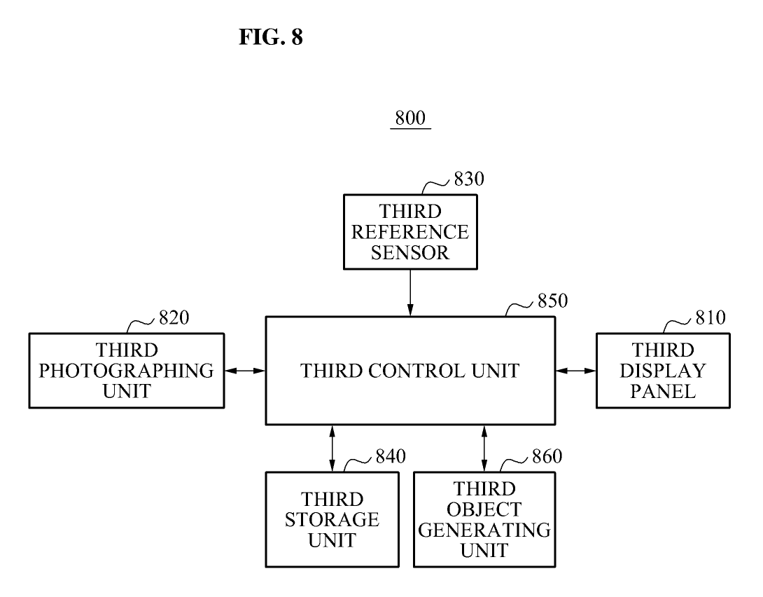

FIG. 8 is a block diagram illustrating an apparatus 800 according to an exemplary embodiment of the present invention.

Referring to FIG. 8, the apparatus 800 may be the apparatus 100 of FIG. 1.

The apparatus 800 may include a third display panel 810, a third photographing unit 820, a third reference sensor 830, a third storage unit 840, a third control unit 850, and a third object generating unit 860.

The third display panel 810, the third photographing unit 820, the third reference sensor 830, the third storage unit 840, the third control unit 850, and the third object generating unit 860 may be similar to the first display panel 210, the first photographing unit 220, the first reference sensor 250, the first storage unit 260, the first control unit 270, and the first object generating unit 271, and thus, detailed descriptions thereof may be omitted herein.

However, the apparatus 800 may recognize a change in a line of sight of a user by comparing photographic data measured by the third photographing unit 810 with facial proportion data stored in the third storage unit 840, without using a direction sensor and an inclination sensor. Also, the apparatus 700 may generate a 3D object having a vanishing point varying depending on a relative angle similar to the apparatus 800 to the line of sight of the user.

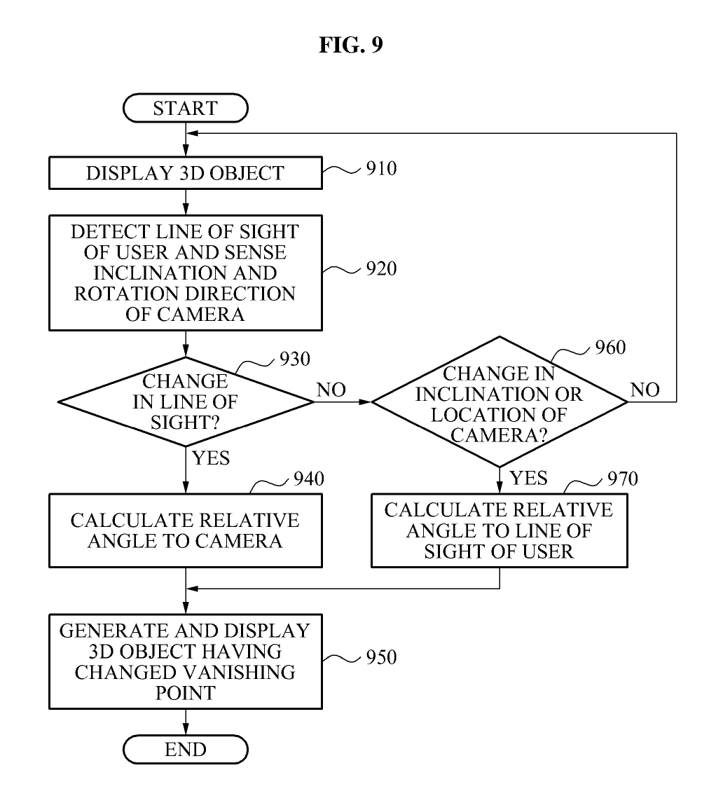

FIG. 9 is a flow chart illustrating a method for displaying a 3D object in an apparatus according to an exemplary embodiment of the present invention. Referring to FIG. 9, the method may be performed by the apparatus 200 of FIG. 2.

In operation 910, the apparatus may display a 3D object if the apparatus operates in a 3D mode.

In operation 920, the apparatus may detect a line of sight of a user by a camera of the apparatus, and may sense a rotation direction and an inclination by a direction sensor and an inclination sensor. In operation 930, the apparatus may recognize a change in the line of sight of the user by comparing photographic data measured by the camera with stored facial proportion data.

If the apparatus recognizes a change in the line of sight of the user in operation 930, the apparatus may calculate a relative angle of the apparatus (that is, the camera) to the line of sight of the user in operation 940.

In operation 950, the apparatus may generate and display a 3D object having a vanishing point changed based on the calculated relative angle.

If there is no change in the line of sight of the user in operation 930, and the apparatus senses a change in the inclination or the rotation direction of the camera in operation 960, the apparatus may calculate a relative angle of the apparatus (that is, the camera) to the line of sight of the user in operation 970. In this instance, because there is no change in the line of sight of the user, the apparatus may set a rotation angle of the camera as the relative angle.

The apparatus may generate and display a 3D object having a vanishing point corresponding to the relative angle calculated in operation 970 in operation 950.

As described above, FIG. 9 shows a first operation that the apparatus is rotated and a second operation that the face of the user is rotated. If the first operation and the second operation occur simultaneously, a 3D object may be generated and displayed in a way similar to the method of FIG. 9. In the second operation, the line of sight of the user may be changed.

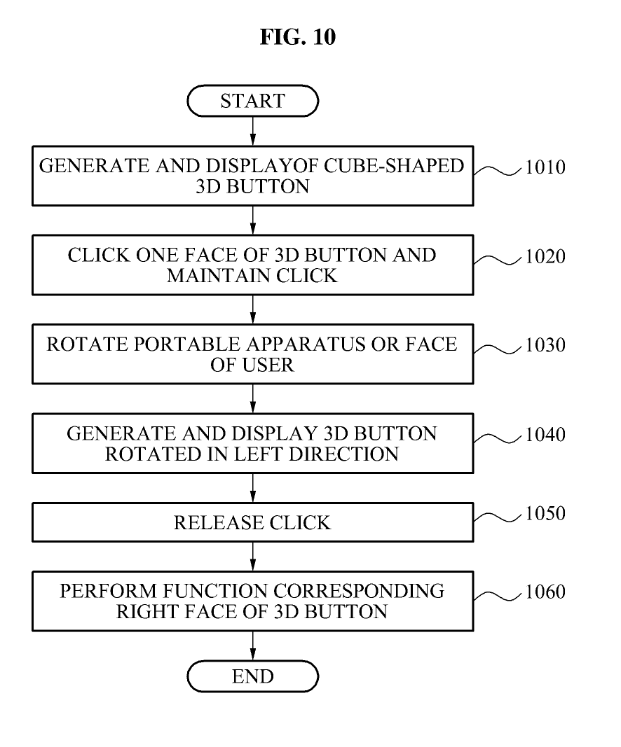

FIG. 10 is a flow chart illustrating a method for displaying various faces of a 3D object by varying a vanishing point of the 3D object according to an exemplary embodiment of the present invention. The method of FIG. 10 may be performed subsequently to operation 950 of FIG. 9.

In operation 1010, the apparatus may generate and display a polyhedral 3D button. The polyhedral 3D button may have a cubic shape; however, the shape of a 3D object is not limited to a cube. The 3D button may be the 3D object of operation 950 or the 3D button of FIG. 6.

In operation 1020, if the user touches or clicks one face of the 3D button and maintains the touch, the apparatus may maintain the touched state. The one face of the 3D button may be, for example, a face displaying the icon 511 of FIG. 6.

If a line of sight of the user is changed by a left rotation of the apparatus or a right rotation of the face of the user while the touch is maintained, in operation 1030, the apparatus may generate and display the 3D button rotated in a left direction in operation 1040. That is, the apparatus may rotate the 3D button displayed in operation 1010 in a left direction so that a right face of the 3D button is displayed toward the user. The right face of the 3D button displayed toward the user in operation 1040 may be a face displaying the icon 514 of FIG. 6. That is, if at least one of a first operation and a second operation occurs, the first operation that the apparatus is rotated while the user is touching one of plural faces of the 3D button and the second operation that the face of the user is rotated while the user is touching one of plural faces of the 3D button, the apparatus may rotate the displayed 3D button in a rotation direction of the apparatus so that other face of the 3D button is displayed toward the user.

If the user releases the touch of the icon 511 in operation 1050, the apparatus may perform a function corresponding to the right face of the 3D button in operation 1060.

Exemplary embodiments of the present invention may be also applied to a 3D object display technology using a head tracking scheme. If an apparatus has at least two cameras, a change in a line of sight or a point of sight of a user may be recognized.

Although exemplary embodiments of the present invention show motion recognition of an apparatus based on rotation in an x direction and a y direction, the present invention may generate a 3D object through motion recognition of an apparatus based on a wheel-like rotation, a shaking operation, and the like.

Exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to display a three-dimensional (3D) object, the apparatus comprising:
a display panel to display the 3D object having plural faces;
an object generating unit to rotate the displayed 3D object in a rotation direction of the apparatus to display a second face of the 3D object toward the user if at least one of a first operation and a second operation occurs, the first operation being that the apparatus is rotated while a user touches a first face of the plural faces of the 3D object and the second operation being that the face of the user is rotated while the user touches the first of the plural faces of the 3D object; and
a control unit to perform a function mapped to the second face displayed toward the user.

2. The apparatus of claim 1, wherein the control unit performs the function if a user command requesting performance of the function is inputted.

3. The apparatus of claim 2, wherein the user releases the touch to input the user command if the second face of the 3D object is displayed toward the user.

4. The apparatus of claim 1, wherein the object generating unit enlarges the second face of the 3D object by rotating the 3D object at an angle greater than the rotation angle of the apparatus.

5. The apparatus of claim 1, wherein the displayed 3D object is a cube-shaped stereoscopic object, and the faces of the cube-shaped stereoscopic object displayed toward the user vary depending on the rotation direction of the apparatus.

6. The apparatus of claim 1, further comprising:
a photographing unit to photograph the user and output photographic data; and
a storage unit to store facial proportion data of the user taken by the photographing unit,
wherein the control unit determines a direction of a line of sight of the user by comparing the photographic data with the stored facial proportion data, and generates a 3D object having a vanishing point varying depending on the determined direction of a line of sight.

7. The apparatus of claim 1, further comprising:
a reference sensor to set a reference coordinate system of the photographing unit; and
a direction sensor to sense a rotation direction of the photographing unit relative to the reference coordinates system,
wherein the object generating unit changes a face of the 3D object displayed toward the user among the plural faces of the 3D object by rotating the 3D object in the sensed rotation direction.

8. The apparatus of claim 1, further comprising:
a reference sensor to set a reference coordinate system of the photographing unit; and
an inclination sensor to sense an inclination of the photographing unit relative to the reference coordinate system,
wherein the object generating unit changes a face of the 3D object displayed toward the user among the plural faces of the 3D object by rotating the 3D object according to the sensed inclination.

9. A method for displaying a 3D object of an apparatus, the method comprising:
displaying the 3D object having plural faces;
detecting occurrence of at least one of a first operation and a second operation, the first operation being that the apparatus is rotated while a first face of the plural faces of the 3D object is touched by a user and the second operation being that the face of the user is rotated while the first face of the plural faces of the 3D object is touched by the user;
rotating and displaying the displayed 3D object in a rotation direction of the apparatus so that a second face of the 3D object is displayed toward the user; and
performing a function mapped to the second face displayed toward the user.

10. The method of claim 9, wherein the performing the function comprises performing a function if a user command requesting performance of the function is generated.

11. The method of claim 10, wherein the user command is generated if the second face of the 3D object is displayed toward the user and the touch is released.

12. The method of claim 9, wherein the rotating and displaying the 3D object comprises enlarging the second face of the 3D object by rotating the 3D object at an angle greater than a rotation angle of the apparatus.

13. The method of claim 9, wherein the displayed 3D object is a cube-shaped stereoscopic object, and the faces of the cube-shaped stereoscopic object displayed toward the user vary depending on the rotation direction of the apparatus.

14. The method of claim 9, further comprising:
photographing the user and outputting photographic data;
determining a direction of a line of sight of the user by comparing the outputted photographic data with stored facial proportion data of the user; and
generating a 3D object having a vanishing point varying depending on the determined direction of a line of sight.

15. The method of claim 9, wherein the rotation direction of the apparatus is sensed by at least one of sensing a rotation direction of the apparatus and sensing an inclination of the apparatus.

16. An apparatus to display a three-dimensional (3D) object, the apparatus comprising:
a display panel to display the 3D object having plural faces;
an object generating unit to rotate the displayed 3D object in a relative direction of the apparatus with respect to a user while the user touches a first face of the 3D object to display a second face of the 3D object toward the user according to a relative angle of the apparatus with respect to the user; and
a control unit to perform a function mapped to the second face displayed toward the user if the touch of the first face of the 3D object is released.

17. The apparatus of claim 16, wherein the relative angle of the apparatus comprises at least one of an angle of rotation of the apparatus with respect to the user and an angle of inclination of the apparatus with respect to the user.
